(19) United States
(12) Patent Application Publication
(10) Pub. No.: US 2008/0186962 A1
(43) Pub. Date: Aug. 7, 2008

(54) Policy-Based Tunneling of Multicast Streams

(75) Inventor: Santanu Sinha, Cupertino, CA (US)

Correspondence Address: Law Office of Mark J. Spolyar, 38 Fountain Street, San Francisco, CA, 94114, US

(73) Assignee: Cisco Technology, Inc., San Jose, CA (US)

(21) Appl. No.: 11/670,294

(22) Filed: Feb. 1, 2007

(51) Int. Cl. H04L 12/56

(52) U.S. Cl. 370/389

(57) ABSTRACT

A policy-based multicast tunneling system. In particular implementations, a method includes maintaining a plurality of multicast tunnels with one or more remote network elements, each multicast tunnel being operable to carry one or more multicast streams; forwarding one or more packets of a multicast stream using selected multicast tunnels of the plurality of multicast tunnels; and applying one or more policies operative to control subscriptions to one or more of the plurality of multicast tunnels.

### TECHNICAL FIELD

This disclosure relates generally to multicast streams.

### BACKGROUND

Market adoption of wireless LAN (WLAN) technology has exploded, as users from a wide range of backgrounds and vertical industries have brought this technology into their homes, offices, and increasingly into the public air space. This inflection point has highlighted not only the limitations of earlier-generation systems, but also the changing role that WLAN technology now plays in people's work and lifestyles across the globe. Indeed, WLANs are rapidly changing from convenience networks to business-critical networks. Increasingly users are depending on WLANs to improve the timeliness and productivity of their communications and applications, and in doing so, require greater visibility, security, management, and performance from their network.

Multicast is the delivery of information to a group of destination nodes simultaneously over a network. In some networks, a multicast message is one that is transmitted to selected multiple recipients who have joined a corresponding multicast group. The sender has to generate only a single data stream. A multicast-enabled router or other network element generally forwards a multicast message to a particular network only if there are multicast receivers on that network. Other stations on that network may filter out multicast packets at the hardware level.

Clients typically subscribe to multicast streams using a subscription protocol. In many network deployments, the delivery of multicast traffic involves the dynamic configuration of one or more hierarchical routing and/or switching topologies (multicast trees) among nodes (such as routers, distribution switches, central controllers, access points, etc.). In some implementations, clients transmit join requests that are snooped by one or more network elements in the network infrastructure that process the message and possibly join the hierarchical multicast tree for that stream. In some deployments, the source of the multicast stream is the root of the multicast tree. At any given time, there may be multiple separate multicast trees in a network given the disparate possible sources of multicast traffic.

Wireless networks, affording mobility of the multicast stream source and/or sink(s), present certain problems given that the multicast delivery configuration must change as the source and/or sink(s) are physically moved and associate with new elements in the network. In response, a multicast tunnel overlay within the network infrastructure can be configured where the root of the multicast tunnel is a network element. All multicast streams are delivered through the multicast tunnel overlay. In this configuration, multicast streams are tunneled within the multicast tunnel overlay, which itself is a multicast stream, which network elements join as needed to deliver streams downstream to wireless clients. Mobility of stream sinks and sources is addressed since the root and other nodes of the multicast tunnel stream hierarchy are typically static allowing other network elements to join the multicast tunnel. If there is no multicast tunnel and the multicast stream source moves then all branches of the tree need to be re-registered. If there is a multicast tunnel from a designated, static root and the multicast source moves, only the new path between that source and the tunnel root will need to be re-registered through multicast protocol (i.e., the tunnel remains static). At each node (e.g., wireless access point, switches, routers, etc.), Internet Group Management Protocol (IGMP) snooping, multicast registration, and execution of other components of multicast protocol is performed by software. Since the software performs other tasks such as learning, route updates, etc., the software response time for multicast-related tasks may widely vary (in order of 10s to 100s of milliseconds). In addition, since a multicast tree update may ripple through many network elements, latencies may accumulate and may disrupt video or voice applications. Hence, for multicast traffic delivery to mobile clients, a relatively stationary tree minimizes disruption of services to a mobile client.

In some wireless network deployments, a central controller delivers multicast streams to wireless clients through a multicast tunnel to which one or more access points have joined. When a wireless client associated with a given access point attempts to join a multicast group, the central controller subscribes to the multicast stream and delivers the multicast stream through the multicast tunnel. When the central controller receives the requested stream, the central controller bundles the stream with other streams, and puts the bundled streams into a single multicast tunnel, where the central controller is the root node for the multicast tunnel. Typically, the wireless access point associated with the client joins or subscribes to the multicast tunnel when the wireless access point has at least one client that is subscribing to at least one stream inside the tunnel. The wireless access point then feeds the stream from the tunnel to the client. For security purposes, if the multicast tunnel is encrypted, a central controller distributes the encryption key to every wireless access point that has wireless clients subscribing to at least one of the streams. A given wireless access point may then use the key to decrypt the tunnel. After decryption, all multicast traffic in the tunnel becomes visible to the wireless access point even though it transmits only the streams to which its clients subscribe. In some systems, the central controller may send each multicast stream in a separate multicast tunnel, where each tunnel is encrypted by a separate key. This requires a network administrator to assign one multicast group address to each tunnel; and the group address should be registered by the Internet Assigned Numbers Authority (IANA) to guarantee that there would be not conflict with other multicast streams.

### DESCRIPTION OF THE DRAWINGS

FIG. 1A illustrates example components in a wireless local area network (WLAN) system.

FIG. 1B illustrates an example hierarchical wireless network including a central controller.

FIG. 1C illustrates an example hardware system, which may be used to implement a wireless access point.

FIG. 2 illustrates an example hardware system, which may be used to implement a wireless access point.

FIG. 3 illustrates an example method associated with establishing a data path for multicast streams.

FIG. 4 illustrates an example method associated with establishing a control path for multicast streams.

FIG. 5 illustrates example components in a wired network multicast system.

### DESCRIPTION OF EXAMPLE EMBODIMENTS

### A. Overview

Particular embodiments provide a multicast system that delivers multicast streams to clients using a policy-based tunneling mechanism. In one implementation, a central controller or other node maintains a plurality of multicast tunnels to which other network elements, such as access points, join in response to multicast group subscriptions of wireless clients. In one implementation, the central controller joins the multicast groups corresponding to various multicast streams and selectively forwards the multicast streams using the multicast tunnels. Access points or other downstream network elements join the multicast tunnels to form multicast trees for the delivery of tunneled multicast traffic. In some particular implementations, the central controller can apply one or more policies operative to control subscriptions to the multicast tunnels and/or the multicast streams that are forwarded within them. Use of multiple multicast tunnels and policies, in some implementations, creates a flexible and scalable architecture allowing the multicast tunnels to be tailored to application, QoS, and/or security attributes of the various multicast streams. As discussed in more detail below, however, the present invention can be applied in other contexts, such as wired networks including distribution switches, routers, and switches.

### B. Example Wireless Network System Architecture

B.1. Network Topology

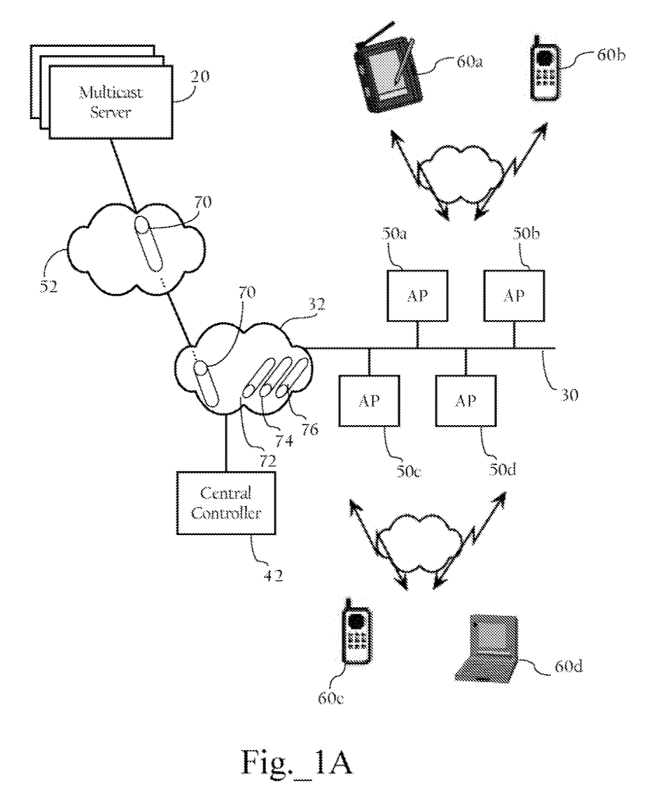

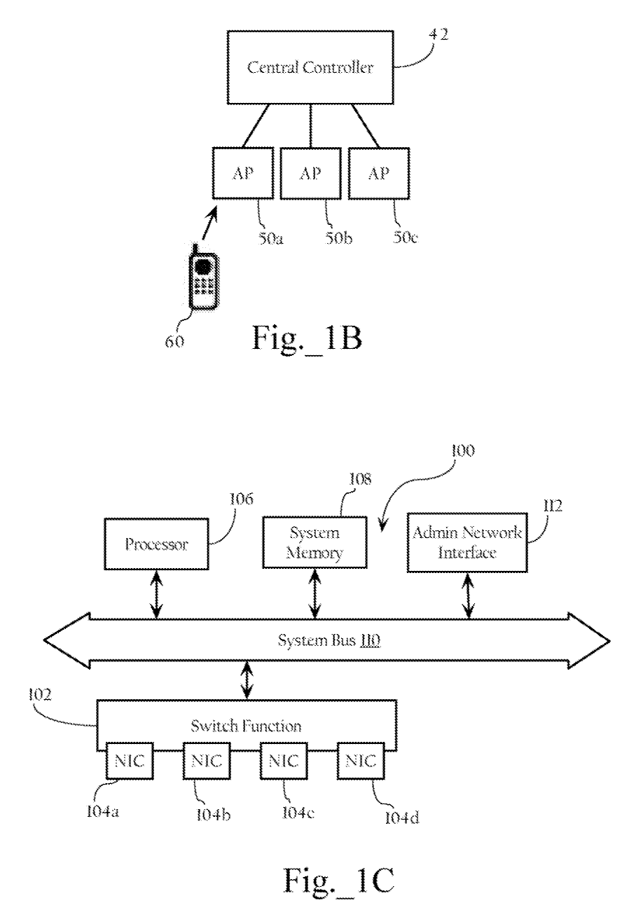

FIG. 1A illustrates example components in a wireless local area network (WLAN) system operably connected to other remote elements in a network environment. In a specific embodiment of the present invention, the network environment includes one or more multicast servers 20, a first network 52, a second network 32, a central controller 42, a local area network (LAN) 30, and wireless access points 50a, 50b, 50c, and 50d. As FIG. 1A shows, the central controller 42 may implement multicast tunnels 72, 74, and 76 between the central controller 42 and the wireless access point 50. LAN 30 is implemented by a switch (or an array of switches) and/or other network devices, such as a bridge.

Networks 52 and 32, in one implementation, generally refer to computer networks, such as a LANs, a WANs, etc., that include one or more intermediate network devices (e.g., routers, switches, etc.), which allow for the transmission of streams between the multicast servers 20 and wireless clients via central controller 42 and wireless access points 50. Of course, networks 52 and 32 can include a variety of network segments, transmission technologies and components, such as terrestrial WAN links, satellite links, optical fiber links, and cellular links. Networks 52 and 32 could also be campus LANs. LAN 30 may be a LAN, LAN segments implemented by an Ethernet switch (not shown), or an array of switches having multiple ports to which wireless access points 50 are connected. The wireless access points 50 are typically connected to switch ports via Ethernet links; however, other link layer connection protocols or communication means can be employed. FIG. 1A illustrates one possible network environment in which the invention may operate; however, other implementations are possible. For example, although WLAN management server 20 is illustrated as being on a different LAN or LAN segment, it may be co-located with wireless access points 50.

The wireless access points 50 are operative to wirelessly communicate with remote wireless client devices 60a, 60b, 60c, and 60d. In one implementation, the wireless access points 50 implement the wireless network protocol specified in the IEEE 802.11 WLAN specification: of course, other wireless network protocols may be used. The wireless access points 50 may be autonomous or so-called “fat” wireless access points, or light-weight wireless access points operating in connection with a wireless switch (see FIG. 1B). In addition, the network infrastructure may also include a Wireless LAN Solution Engine (WLSE) offered by Cisco Systems, Inc. of San Jose, Calif. or another wireless network management system. In some implementations, the network infrastructure may also include one or more Wireless Control System (WCS) nodes operative to manage one or more wireless switches and access points.

Multicast servers can provide video streams, audio streams, and other media or data streams. In some implementations, multicast servers can be client nodes implementing push-to-talk functionality. Given the different sources and types of multicast traffic, multicast streams have varying application, QoS and/or security requirements. Multicast servers may be collated within the same LAN or network segment as one or more clients, or be connected over a routed network.

Central controller 42 is operative to maintain a plurality of multicast tunnels, each having an IP address. The IP address of some multicast tunnels may be common across central controllers where the multicast tunnels are not encrypted. In particular implementations, each tunnel can be differentiated by a policy set (including one or more of application requirements, service availability requirements (e.g., push-to-talk), QoS requirements, security requirements, available bandwidth (especially where the multicast tunnel traverses a WAN).

As discussed below, central controller 42 joins individual multicast streams on behalf of one or more wireless clients; that is, central controller 42, in one implementation, snoops join requests transmitted by wireless clients. Responsive to the join requests, the central controller 42 executes one or more policies to select a multicast tunnel within which the requested stream will be forwarded and configures one or more access points to receive the multicast tunnel stream. In one implementation, multicast join requests are forwarded within the network environment until encountered by a node in corresponding multicast trees of the different multicast groups. In some implementations, the network environment may also provide for multicast tunneling of multicast streams. In one such implementation, the central controller 42 may join one or more of such multicast tunnel groups as required to receive multicast streams requested by downstream clients. The central controller 42, when receiving packets of a multicast stream, forwards the received packets using the appropriate multicast tunnel. Subsequent join requests to the same multicast group can be served based on the previous subscription by the central controller.

B.2. Central Controller

FIG. 1B illustrates an example hierarchical wireless network including a central controller 42 according to one implementation of the present invention. In one implementation, the central controller 42 may be implemented as a wireless domain server (WDS) or, alternatively, as a wireless switch. If the central controller 42 is implemented with a WDS, the central controller 42 is operative to communicate with autonomous or so-called “fat” wireless access points. If the central controller 42 is implemented as a wireless switch, the central controller 42 is operative to communicate with light-weight wireless access points and process wireless protocol and network management information. As FIG. 1B illustrates, a central controller 42 may be directly connected to one or more access points 50. Alternatively, a central controller 43 may be operably connected to one or more access points over a switched and/or routed network environment, as FIG. 1A illustrates.

FIG. 1C illustrates an example hardware system 100, which may be used to implement a central controller 42. As FIG. 1C shows, in one implementation, the central control elements each comprise a switch function or fabric 102 comprising a network interface 104a (e.g., an Ethernet adapter) for connection to network 52 and network interfaces 104b, 104c, and 104d for connection to wireless access points. This switch function or fabric is implemented to facilitate connection to the access elements. Central controller 42, in one implementation, further comprises a processor 106, a memory 108, one or more software modules stored in memory 108, including instructions for performing the functions described herein, and a system bus 110 operably connecting these components. The central control elements may optionally include an administrative network interface 112 allowing for administrative access for such purposes as configuration and diagnostic access. In other implementations, central controller 42 includes a single network interface.

B.3. Wireless Access Point

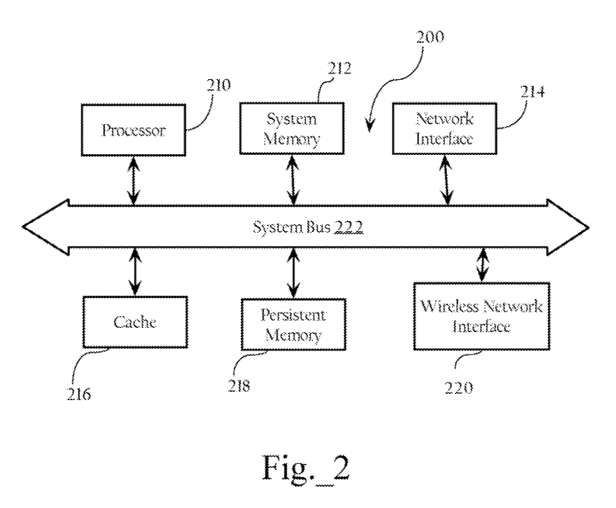

FIG. 2 illustrates an example hardware system 200, which may be used to implement a wireless access point 50. In one implementation, the system 200 includes a processor 210, a memory 212, a network interface 214 (e.g., an 802.3 interface) for communication with a LAN, a cache 216 for storing WLAN information, a persistent memory 218, a wireless network interface 220 (e.g., an IEEE 802.11 WLAN interface) for wireless communication with one or more wireless clients 60, and a system bus 222 interconnecting these components. The wireless access points 50 may also include software modules (including Dynamic Host Configuration Protocol (DHCP) clients, transparent bridging, Lightweight Access Point Protocol (LWAPP), Cisco® Discovery Protocol (CDP) modules, wireless access point modules, Simple Network Management Protocol (SNMP) functionality, etc., and device drivers (e.g., network and WLAN interface drivers) stored in persistent memory 218 (e.g., a hard disk drive, flash memory, EEPROM, etc.). At start up, these software components are loaded into system memory 212 and then accessed and executed by processor 210. In one implementation, wireless access point is operative to establish a tunnel with central controller for wireless client traffic. For example, wireless access point 50 transmits wireless management and data traffic to a corresponding central controller. In this manner, central controller 42 is operatively disposed to snoop multicast join requests and other control traffic.

### C. Policy-Based Tunneling of Multicast Streams

As described in more detail below, implementations of the invention deliver multicast streams to clients using policy-based tunneling of the multicast streams. Referring again to FIG. 1A, when a client 60 requests to join a multicast stream, central controller 42 joins the multicast group on behalf of client. In one implementation, central controller 42 is operable to implement N separate multicast tunnels for the delivery of various multicast streams to clients associated with one or more of the wireless access points 50. In one implementation, each multicast tunnel is assigned a non-conflicting multicast group address. Wireless access points 50 join the multicast tunnels to provide multicast stream tunneled within them to one or more wireless clients. Central controller 42 may also assign encryption keys to one or more of the multicast tunnels. Some multicast group IP addresses may be common across multiple central controllers if the tunnel associated with a given multicast address is not encrypted.

In some implementations, N may be limited to a fewer number of tunnels (e.g., N=4 to 8). Using fewer tunnels reduces scaling issues in terms of the number of registered multicast addresses for tunnels and the number of keys needed for the tunnels.

C.1. Tunneling Policies

In one implementation, the multicast system applies a tunnel policy set to each multicast tunnel. The tunnels are thus differentiated by the tunnel policy sets. Tunnel policy sets may be configured to define various operational parameters or modes for a given multicast tunnel, such as 1) which multicast streams should be carried within a given multicast tunnel, 2) which access points may subscribe to a given multicast tunnel, and 3) when an access point should join a multicast tunnel (e.g., on-demand or pre-joining). In one implementation, the tunnel policies are based on various attributes or properties of the multicast streams and the network endpoints (e.g., wireless access points). A given tunnel may carry one or more multicast streams having the same or similar properties. In one implementation, properties may be associated with security attributes, bandwidth limitations of network links, subscriptions, availability of network nodes for a particular stream such as push-to-talk streams, Quality of Service (QoS)(e.g., time sensitivity), application requirements, etc. In one implementation, the policies may be configured by a network administrator.

In one implementation, a given multicast tunnel may be security sensitive, and a given stream may be associated with a particular security profile (e.g., sensitive, public, etc.). In one implementation, if a given stream is security sensitive, the stream may be associated with a security level (e.g., high, medium, low, etc.), where the stream is sent in a tunnel that is encrypted. As such, different streams having different security levels may be sent in different tunnels, where each tunnel is individually encrypted. In one implementation, if a given stream is public, the stream may be sent in a tunnel that is not encrypted.

In one implementation, a multicast tunnel may be associated with a link bandwidth. Utilizing separate tunnels enables conservation of bandwidth. For example, if a particular tunnel passes through a low-bandwidth link, central controller 42 may send only multicast streams that require less bandwidth (e.g., voice data).

In one implementation, a multicast tunnel may be associated with a policy operative to control the timing of subscriptions. For example, in one implementation, a multicast tunnel may be associated with push-to-talk streams, which may require less bandwidth, but are time sensitive (e.g., latency sensitive, jitter sensitive, etc.). Push-to-talk streams typically require reliable, continuous availability at various distribution switches. As such, in one implementation, distribution switches may prejoin multicast tunnels that deliver push-to-talk streams. By prejoining push-to-talk multicast tunnels, a given distribution switch is ready to provide push-to-talk streams to a client before the client sends a join request. Because the distribution switch can immediately forward the requested push-to-talk stream to the client, there would be no need for the distribution switch to forward the join request to the central controller. The benefit of prejoining a policy-based push-to-talk multicast tunnel stream is that the propagation of the join request is typically limited to a small network segment between the wireless client and a distribution switch. As a result, any latency associated with multicast tree updates when a push-to-talk client moves to a prejoined distribution switch on a different network (e.g., a different building on the same campus) is bound. In one implementation, a policy can be configured to have access points prejoin one or more multicast tunnels upon initialization or startup. In other words, while an access point may join a push-to-talk multicast tunnel when instructed by the central controller, policy may be configured to have an access point dynamically prejoin a push-to-talk multicast tunnel. For example, a policy for a multicast tunnel for push-to-talk streams can be configured to cause access points to prejoin the multicast tunnel to reduce join latency associated with providing wireless clients access to a push-to-talk multicast stream. For example, if a client sends a join request for a push-to-talk stream to an access point that has prejoined the push-to-talk stream, the access point can immediately forward the push-to-talk stream to the client thereby reducing join latency.

In one implementation, other policies can control the access points allowed to subscribe to a given multicast tunnel. For example, a multicast tunnel policy may be configured relative to one or more attributes of the access points. For example, a tunnel policy set may be configured relative to network topology attributes. For example, a policy can be configured to prevent multicast tunnels for security sensitive traffic to be established over a WAN. In other implementations, a policy can be configured to prevent subscriptions to certain multicast tunnels that carry secured traffic for access points in unsecured or public locations.

C.2. Control Path for Multicast Streams

The following describes the establishment of a data path for delivering multicast streams to clients through appropriate multicast tunnels. The process, in one implementation, involves applying the tunnel policies described above to select a multicast tunnel for a given multicast stream.

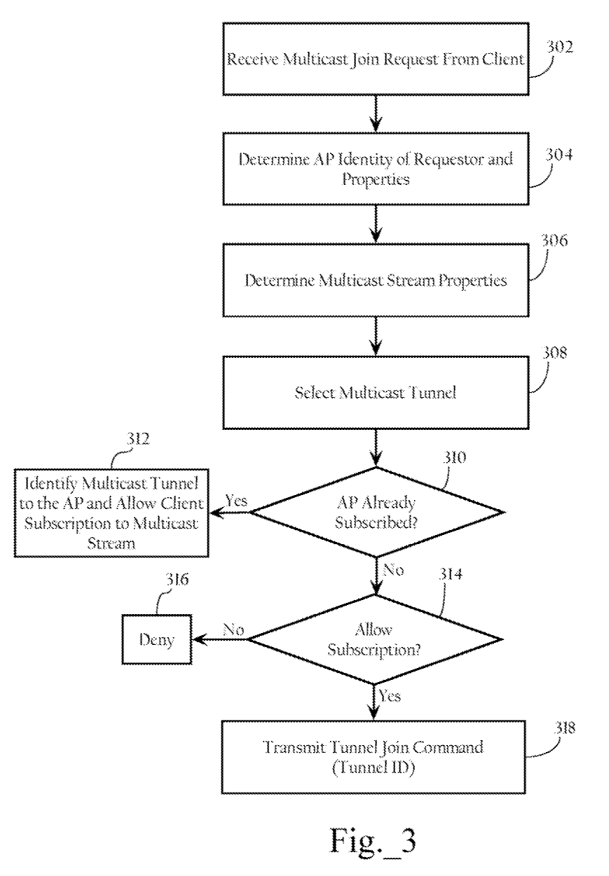

FIG. 3 illustrates an example method associated with establishing a data path for multicast streams. As FIG. 3 shows, when a client attempts to join a particular multicast stream, the client transmits a multicast join request (such as an Internet Group Management Protocol (IGMP) join request), which is forwarded within the network environment until it reaches a network element in the multicast tree for the multicast stream identified in the multicast join request. After central controller 42 receives the multicast join request for a multicast stream (302), central controller 42 determines the wireless access point identity of the requestor (i.e., the wireless access point associated with the requesting client) and one or more attributes of the identified wireless access point (304). Wireless access point properties may include subscription information, physical security, location (e.g., in building, out of building, etc.), node type (e.g., mesh, corporate, internal, guest access, etc.).

The central controller 42 then determines one or more attributes of the multicast stream (306). As described above, multicast stream properties may correspond to security parameters or requirements, wireless access point attributes, bandwidth limitations of network links, subscriptions, availability of network nodes for a particular stream such as push-to-talk streams, Quality of Service (QoS)(e.g., time sensitivity), application requirements, etc. The central controller then selects a multicast tunnel from a plurality of N multicast tunnels to carry the multicast stream (308). Central controller 42 may apply a variety of policies to select a multicast tunnel. In one implementation, the central controller 42 selects the tunnel based on a combination of the wireless access point properties and the multicast stream properties. For example, in one implementation, a given multicast tunnel may deliver streams that require security measures, such as encryption. In another implementation, a multicast stream including sensitive information may be delivered in an encrypted multicast tunnel, if the wireless access points are disposed across a WAN. Otherwise, an unencrypted tunnel can be used. In another implementation, central controller 42 may access a table that maps one or more multicast streams (identified by group address, for example) to a multicast tunnel.

A variety of policies can be implemented. For example, in one implementation, a policy may require that the central controller not distribute keys for secured tunnels to wireless access points that are considered to be not physically secure. In one implementation, wireless access points that do not have any client subscribing to a stream in a multicast tunnel may not receive that multicast tunnel and key to the tunnel. In one particular example, central controller 42 may send sensitive multicast streams in a separate tunnel and distribute keys only wireless access points in a select portion of the network (e.g., inside a given building or set of buildings). Accordingly, this policy keeps particular streams away from wireless access points that are not physically in a building of the network. In another example, central controller 42 may send all non-sensitive subscribed multicast streams in one multicast tunnel, where the contents are in the clear (i.e., the tunnel is not encrypted). This may be useful for clients in a guest network, where streams may come from the Internet and corporate multicast streams to which guests are permitted to subscribe. As such, all wireless access points that have associated clients in the guest network can subscribe to that tunnel without needing a key for the tunnel.

The central controller then determines if the wireless access point is already subscribed to the selected multicast tunnel (310). If yes, central controller 42 identifies the tunnel to the wireless access point and allows the client's subscription to the multicast stream (312). If not, central controller 42 applies one or more policies to determine whether to allow the wireless access point to which the client is associated to subscribe to the selected multicast tunnel (314). For example, central controller 42 may or may not allow the subscription, depending on whether the wireless access point has a required encryption key, depending on the physical location of the wireless access point, etc. If central controller 42 does not allow the subscription to the required multicast tunnel, central controller 42 denies the join request (316). The central controller 42 can explicitly deny the request by transmitting a rejection reply to the wireless client. In another implementation, the central controller 42 may simply discard the join request. If central controller 42 does not allow the subscription, central controller 42 transmits a tunnel join command to the wireless access point (318). More specifically, central controller 42 sends a group address (or tunnel ID) for the appropriate tunnel to the wireless access point and instructs the wireless access point to join that tunnel. If the tunnel is encrypted, central controller 42 also sends one or more encryption keys to the wireless access point. As discussed below, packets of the multicast stream are delivered within the selected multicast tunnel to which the access point subscribed. The access point receives packets of the multicast stream in the multicast tunnel and forward them to one or more wireless clients.

C.3. Data Path for Multicast Streams

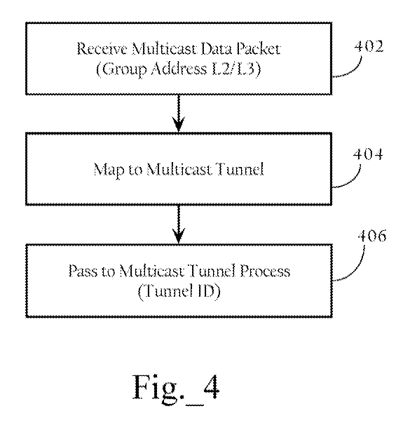

FIG. 4 illustrates an example method associated with establishing a control path for multicast streams. As described above, when a client requests to join a particular multicast stream, the client sends a multicast join request to the appropriate multicast server 20 via the central controller 42. The multicast server 20 then sends the requested stream to central controller 42 via tunnel 70. After central controller 42 receives a multicast data packet (402), central controller 42 maps the multicast data packet to a tunnel according to a group address (404). In one implementation, the multicast data packet may have an associated Layer 2 or Layer 3 group address (or tunnel ID) for a given tunnel. The central controller sends the multicast data packet to the tunnel process (406). The tunnel process can implement one or more operations, such as encryption, QoS, buffering, and encapsulation of packets.

C.4. Example Wired Network Multicast Architecture

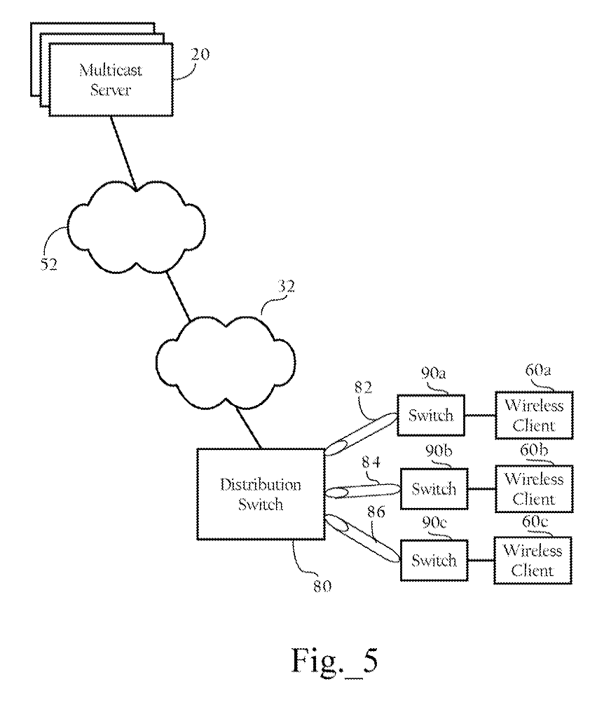

FIG. 5 illustrates example components in a wired network multicast system. The wired network system of FIG. 5 is similar to that of FIG. 1A in that the wired network system includes one or more multicast servers 20, a network 52, a network 32, and wireless access points 50a, 50b, 50c, and 50d. The wired network system of FIG. 5 is different in that it includes a distribution switch 80 instead of a central controller 42, and includes one or more switches 90a, 90b, and 90c instead of wireless access points. In one implementation, distribution switch 80 may implement the policy-based multicast tunnel functionality discussed above in connection with FIGS. 3 and 4, and switches 82-86 operate similarly to wireless access points 50. The wired network system also includes multicast tunnels 82, 84, and 86 coupled between the distribution switch 80 and switches 82-86.

The present invention has been explained with reference to specific embodiments. For example, while embodiments of the present invention have been described as operating in connection with IEEE 802.11 networks (e.g., FIG. 1A) and with a wired network (e.g., FIG. 5), the present invention can be used in connection with any suitable network environment. Other embodiments will be evident to those of ordinary skill in the art. It is therefore not intended that the present invention be limited, except as indicated by the appended claims.

What is claimed is:

1. An apparatus comprising:
one or more processors;
one or more network interfaces; and
logic encoded in one or more tangible media for execution and when executed operable to cause the apparatus to:
maintain a plurality of multicast tunnels with one or more remote network elements, each multicast tunnel being operable to carry one or more multicast streams;
forward one or more packets of a multicast stream using selected multicast tunnels of the plurality of multicast tunnels; and
apply one or more policies operative to control subscriptions to one or more of the plurality of multicast tunnels.

2. The logic of claim 1 wherein the logic is further operable to cause the one or more processors to:
access a multicast join request transmitted by a client, wherein the multicast join request identifies a multicast stream; and
select a multicast system from the plurality of multicast tunnels for the multicast stream.

3. The logic of claim 1 wherein logic is further operable to cause the one or more processors to:
determine an identity of a wireless access point associated with a client;
determine one or more attributes of the wireless access point;
determine one or more attributes of the multicast stream; and
select the multicast tunnel based on the one or more policies.

4. The logic of claim 3 wherein the one or more policies are based on a combination of the one or more attributes of the wireless access point and the one or more attributes of the multicast stream.

5. The logic of claim 3 wherein the one or more attributes of the multicast stream are associated with security parameters or requirements.

6. The logic of claim 2 wherein the one or more attributes of the multicast stream are associated with bandwidth limitations of network links.

7. The logic of claim 3 wherein the one or more attributes of the multicast stream are associated with an availability of network nodes for particular stream.

8. The logic of claim 1 wherein the logic is further operable to cause the one or more processors to transmit messages operative to cause one or more of the remote network elements to subscribe to a multicast tunnel of the plurality of multicast tunnels.

9. The logic of claim 8 wherein the messages are transmitted in response to detecting a multicast join request of a client.

10. The logic of claim 1 wherein the logic is further operable to cause the one or more processors to join the multicast stream on behalf of a client.

11. The logic of claim 1 wherein the logic is further operable to cause the one or more processors to prejoin the multicast stream to ensure continuous availability of the multicast stream.

12. The logic of claim 1 wherein the logic is further operable to cause the one or more processors to:
receive a packet of a multicast stream, the packet being associated with a multicast group address;
map the packet to a first multicast tunnel of the plurality of multicast tunnels based on the multicast group address; and
transmit the packet via the first multicast tunnel.

13. The logic of claim 1 wherein the logic is further operable to cause the one or more processors to access a table that maps one or more multicast streams to a multicast tunnel.

14. A method comprising:
maintaining a plurality of multicast tunnels with one or more remote network elements, each multicast tunnel being operable to carry one or more multicast streams;
forwarding one or more packets of a multicast stream using selected multicast tunnels of the plurality of multicast tunnels; and
applying one or more policies operative to control subscriptions to one or more of the plurality of multicast tunnels.

15. The method of claim 14 further comprising:
accessing a multicast join request transmitted by a client, wherein the multicast join request identifies a multicast stream; and
selecting a multicast tunnel from the plurality of multicast tunnels for the multicast stream.

16. The method of claim 14 further comprising:
determining an identity of a wireless access point associated with a client;
determining one or more attributes of the wireless access point;
determining one or more attributes of the multicast stream; and
selecting the multicast tunnel based on the one or more policies.

17. The method of claim 14 further comprising:
receiving a packet of a multicast stream, the packet being associated with a multicast group address;
mapping the packet to a first multicast tunnel of the plurality of multicast tunnels based on the multicast group address; and
transmitting the packet via the first multicast tunnel.

18. A system comprising:
a first network infrastructure node operable to maintain a plurality of multicast tunnels with one or more remote network elements, each multicast tunnel being operable to carry one or more multicast streams; forward one or more packets of a multicast stream using selected multicast tunnels of the plurality of multicast tunnels; and apply one or more policies operative to control subscriptions to one or more of the plurality of multicast tunnels; and
a second network infrastructure node operable to establish connections with one or more clients; forward multicast join requests from the one or more clients to the first wireless network infrastructure node; and join one or more of the multicast streams maintained by the first network infrastructure node, and forward one or more multicast streams from the first wireless network infrastructure node to the one or more clients.

19. The system of claim 18 wherein the first network infrastructure node is further operable to:
access a multicast join request transmitted by a client, wherein the multicast join request identifies a multicast stream; and
select a multicast tunnel from the plurality of multicast tunnels for the multicast stream.

20. The system of claim 18 wherein the first network infrastructure node is further operable to:
determine an identity of a wireless access point associated with a client;
determine one or more attributes of the wireless access points;
determine one or more attributes of the multicast stream; and
select the multicast tunnel based on the one or more policies.
